(19) United States
(12) Patent Application Publication
(10) Pub. No.: US 2007/0200043 A1
(43) Pub. Date: Aug. 30, 2007

(54) Hanging Basket Assembly

(76) Inventor: Perry Just, Westland (NZ)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/576,856

(22) PCT Filed: Oct. 20, 2004
(86) PCT No.: PCT/NZ04/00261

§ 371 Date: Nov. 14, 2006

(30) Foreign Application Priority Data
Oct. 20, 2003 (NZ) 529011

(51) Int. Cl. B42F 13/00

(52) U.S. Cl. 248/341

(57) ABSTRACT

The present invention relates to a rigid hanger member (30) for hanging a basket (31) for growing and/or displaying a plant or plants. The rigid hanger member includes a hook member (35), and a plurality of rigid chain members (33). One end of each of the rigid chain members (33) connects to the hook member (35) and the other end of the rigid chain members (33) is attached to the basket (31) or comprises a hook (33a) or clip element for attaching to a basket (31). In one form, each rigid chain member (33) is a rigid support rod and a chain (33b). The present invention provides for a rigid hanging means which assists with the hanging of planting baskets.

### FIELD OF TIE INVENTION

The present invention relates to an improved hanger member for a hanging basket assembly for plants.

### BACKGROUND TO THE INVENTION

It is known to use hanging basket assemblies to hold live, growing plants and flowers or artificial plants or flowers. The hanging baskets are usually lined with sphagnum moss because of its ability to absorb and retain water up to and exceeding 20 times its own weight. Sphagnum moss also has a natural and aesthetically pleasing appearance. Once lined, the baskets are filled with soil and potting mix, and the plants and/or flowers are planted or placed into the composite soil mixture as desired.

Hanging basket assemblies typically comprise a wire basket which receives and retains the sphagnum moss, potting mix, soil, plants, flowers etc. The baskets can be hung in position by a hook which is connected to the basket by a number of chains.

Chains are very important to the overall aesthetic appeal of the hanging basket assemblies, however their use also presents practical problems because of their non-rigid nature. When the hook is not being used, the chains and hook simply collapse into the basket. For this reason it is often necessary for people to use two hands and/or a hanging device when hanging a basket. Further, when shops present pre-arranged hanging basket assemblies complete with planted plants or flowers, but do not display these in a hanging position, the chains and hook simply collapse into the basket and this often damages the plants and/or flowers.

It is an object of the present invention to provide a hanger member for a basket assembly which goes at least someway to alleviating the problems associated with the known hanging basket assemblies, or to at least provide the public with a useful choice.

### SUMMARY OF THE INVENTION

In one aspect, the present invention broadly consists in a rigid hanger member for hanging a basket for growing and/or displaying a plant or plants, including a hook member, and a plurality of rigid chain members, one end of which connects to the hook member and the other end of which is attached to the basket or comprises a hook or clip element for attaching to a basket.

Preferably, each rigid chain member includes a rigid support rod and a chain. In this form, the rigid chain member may be configured so that its respective rigid support rod and chain are adjacent each other for their entire lengths.

Preferably, one end of each rigid support rod is either attached to the basket or formed into or carries a hook or clip element for attaching to a basket, and the other end connects to the hook member.

In a preferred form, one end of each chain is attached to the hook member. It is also preferable for the other end of each chain to be either attached to the basket or attached to a hook or clip element for attaching to a basket.

In an alternate form, one end of each chain is attached to the rigid support rod near the end of the rigid support rod which connects to the hook member. It is preferable in this case for the other end of each chain to be attached to the rigid support rod near the end of the rigid support rod which either attaches to the basket or comprises a hook or clip element for attaching to a basket.

For rigidity, each rigid support rod could be passed or woven through a number of the links of its respective chain. Alternatively or additionally, each chain is fixed to its respective rigid support rod at various points along its length.

The rigid chain member may be composed of a series of chain links which are individually fixed together or a single length of rod or wire pre-formed and/or bent to a sinuous form over its length. In one form, the rigid chain member comprises two or more lengths of rod or wire plaited together.

The hook member is preferably fixedly connected to the rigid chain members in a substantially upright orientation.

The hook or clip element at the other end of each rigid chain member may advantageously comprise an open entry which tapers to a narrow neck.

In another aspect, the present invention broadly consists in a rigid hanger member for hanging a basket for growing and/or displaying a plant or plants, including a hook member, and a plurality of rigid chain members, each rigid chain member having a rigid support rod attached to a chain, wherein one end of each rigid support rod is either attached to the basket or formed into or carries a hook or clip element for attaching to a basket, and the other end connects to the hook member, and wherein one end of each chain is attached to the rigid support rod near the end of the rigid support rod which connects to the hook member and the other end of each chain is attached to the rigid support rod near the end of the rigid support rod which either attaches to the basket or comprises a hook or clip element for attaching to a basket.

In a further aspect, the present invention broadly consists in a rigid hanger member for hanging a basket for growing and/or displaying a plant or plants, including a hook member, a plurality of rigid chain members, each rigid chain member having a rigid support rod attached to a chain, wherein one end of each chain is either attached to the basket or formed into or carries a hook or clip element for attaching to a basket and the other end of each chain fixedly connects to the hook member such that the hook member is supported in a substantially upright orientation.

The rigid hanger member may be provided together with a wire basket for containing a liner, growing media and one or more plants. Also, it may be preferable to provide the rigid hanger member with a basket containing a plant or plants.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples only.

### BRIEF DESCRIPTION OF THE DRAWINGS

A preferred embodiment of the invention will be described by way of example only and with reference to the drawings, in which:

FIG. 1 shows a prior art hanging basket assembly with a sphagnum moss liner installed;

FIG. 2 shows a prior art hanging basket assembly with a plant installed, and in particular illustrates how non-rigid chains collapse into the basket and onto the plant;

FIG. 3 shows a preferred embodiment rigid hanger member together with a basket with a sphagnum moss liner installed into the basket;

FIG. 4 shows a further embodiment rigid hanger member together with a basket;

FIG. 5 shows the rigid hanger member of the hanging basket assembly of FIG. 4;

FIG. 6 shows the rigid support rod of the rigid hanger member of FIG. 5;

FIG. 7 shows an example chain link that is attached to the rigid hanger member of FIG. 6; and

FIG. 8 shows the chain link attached to the rigid hanger member of FIG. 6.

### DETAILED DESCRIPTION OF PREFERRED EMBODIMENTS

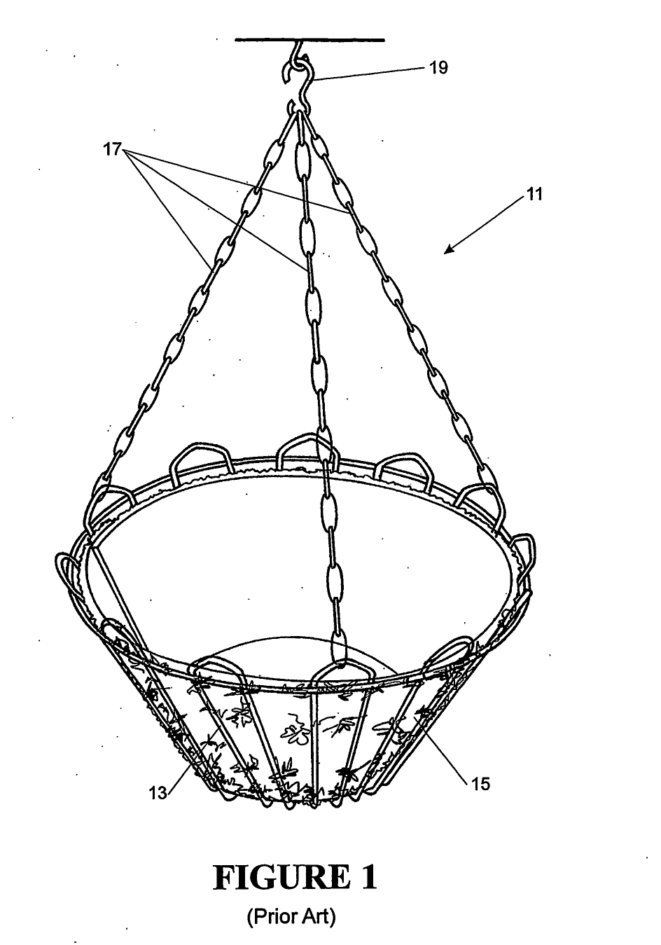

Known hanging basket assemblies, an example of which is shown in FIG. 1 referred to generally by 11, typically comprise a wire basket 13, hook 19, and non-rigid chains 17 which attach the hook 19 to the basket 13. A sphagnum moss liner 15 is also shown installed within the basket 13.

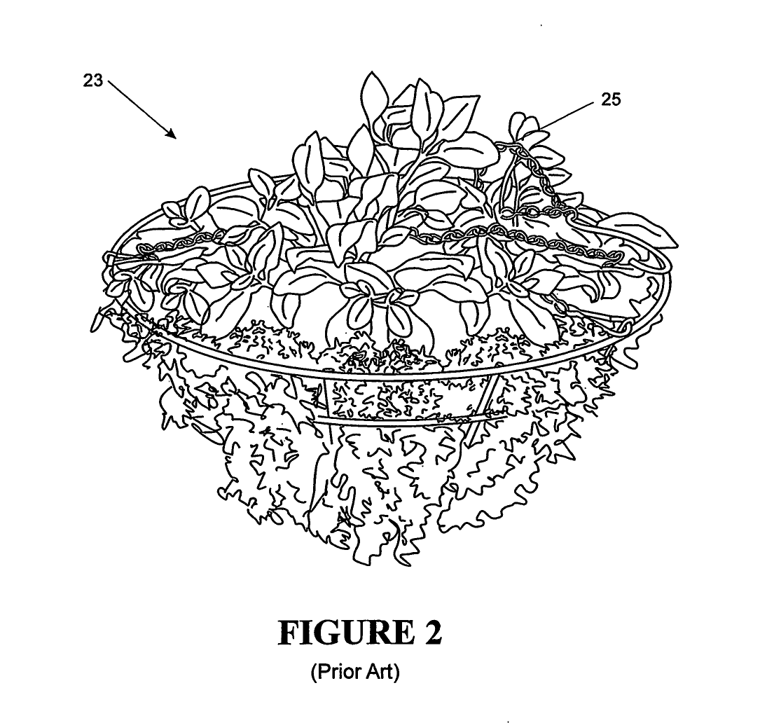

As mentioned, the lack of rigidity of the chains which attach the hook to the basket present practical problems when utilising such hanging basket assemblies. An example of one of the problems is shown FIG. 2, which illustrates a hanging basket assembly of the type shown in FIG. 1 with a plant 23 installed. When the hanging basket assembly is stored in a non-hanging position, where it is supported by the base of the basket rather than being hung by the hook, the non-rigid chains 25 and hook (not shown) collapse into the basket and onto the plant 23. This can result in damage to the plant 23.

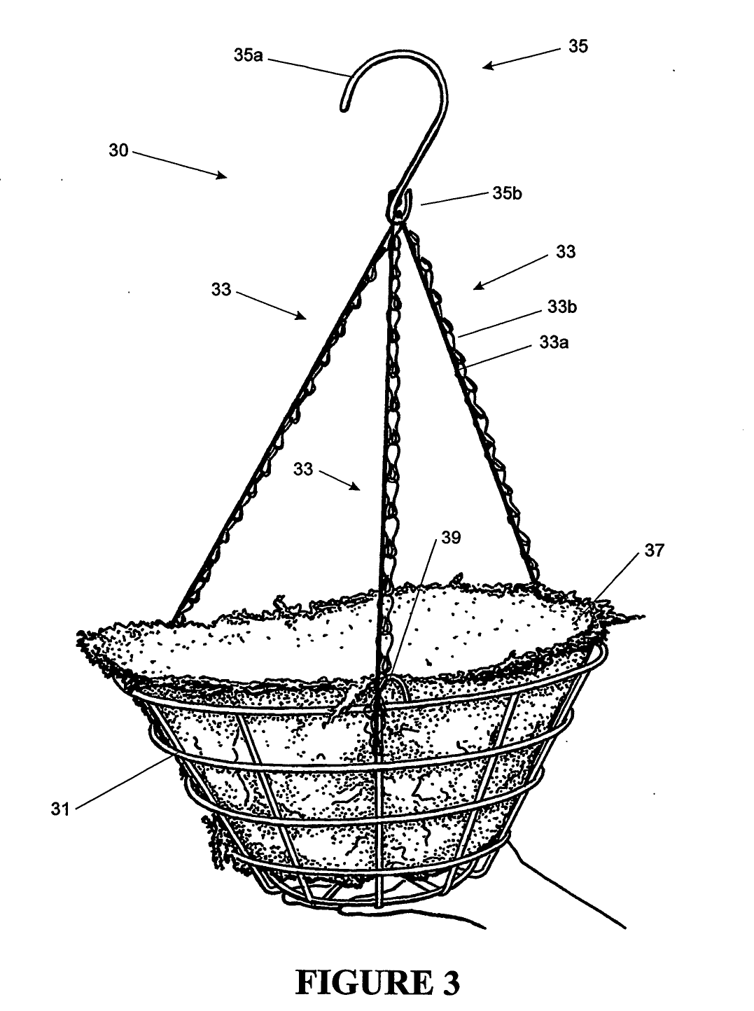

FIG. 3 shows a preferred embodiment of the rigid hanger member of the present invention, generally indicated by 30. In the figure, the rigid hanger member 30 is shown attached to a basket 31. Although basket 31 is shown as a wire framed basket, it will be appreciated that other known basket types could be used, such as plastic or cane baskets.

The rigid hanger member 30 includes a hook member 35 and rigid chain members 33. One end of each of the rigid chain members 33 is attached to the hook member 35 while the other end is attached to the basket 31. In the preferred embodiment, there are three rigid chain members 33, although it will be appreciated that there may be one or more of these in different configurations. The construction of the rigid chain members 33 ensures that they do not collapse into the basket 31 or onto a plant which it may contain when the hook is not in use.

The hook member 35 includes a hook part 35a to facilitate the hanging of the basket 31 and an attachment part 35b to facilitate the attachment of the rigid chain members 33. It will be appreciated that other hanging mechanisms may be used also. For instance, the hook member 35 may be integrally formed and connected with the rigid chain members 33. In particular, the top ends of the rigid chain members may be crimped together and curved to form the hook member 35.

Each rigid chain member 33 includes a rigid support rod 33a and a chain 33b. One end of each rigid support rod 33a is attached to the attachment part 35b of the hook member 35. The attachment may be by virtue of a spot weld for example, although other attachment means could be used. For example, a loop may be formed at the end of the rigid support rod 33a to facilitate a hooking-type attachment with the attachment part 35b of the hook member 35. Alternatively, the top ends of the rigid support rod 33a and/or the chain 33b may be crimped together and curved to form the hook member 35.

The other end of each rigid support rod 33a is attached to the upper peripheral edge of the basket 31. In the preferred embodiment shown, attachment loops 39 are provided about the upper peripheral edge of the wire frame which forms the basket 31. There is an attachment loop 39 for each rigid chain member 33 and the attachment loops are uniformly spaced about the upper peripheral edge of the basket 31. Attachment of each rigid support rod 33a to each respective attachment loop 39 is achieved by a spot weld, although other attachment means may be used as highlighted above in relation to the attachment of the other end of the rigid support rod 33a to the hook member 35. It will be appreciated that attachment loops 39 are not a necessity, and the end of the rigid support rod 33a may be attached directly to the upper peripheral edge or any other part of the basket 31.

Each chain 33b extends substantially along the entire length of its respective rigid support rod 33a. In the preferred embodiment, one end of each chain 33b is attached by virtue of a spot weld to its respective rigid support rod 33a near the end of the rod which attaches to the hook member 35. The other end of each chain 33b is attached by virtue of a spot weld near the other end of its respective rigid support rod 33a which attaches to the basket 31.

At various positions along the length of each rigid chain member 33, the chain 33b may be spot welded to the rigid support rod 33a. Additionally, or alternatively, the rigid chain member 33 may be configured so that the rigid support rod 33a is woven through a number of the links of the chain 33b.

It will be appreciated that each chain 33b does not necessarily have to be attached to its respective rigid support rod 33a. For example, in an alternative arrangement, one end of each chain 33b may be attached directly to the attachment part 35b of the hook member 35, while the other end of each chain 33b may be directly attached to the basket 31. In this alternative embodiment it is preferable that one end of each chain 33b is attached to substantially the same part of the basket 31 as its respective rigid support rod 33a. This ensures that each chain 33b is adjacent to its respective rigid support rod 33a along the entire length of the rigid chain member 33.

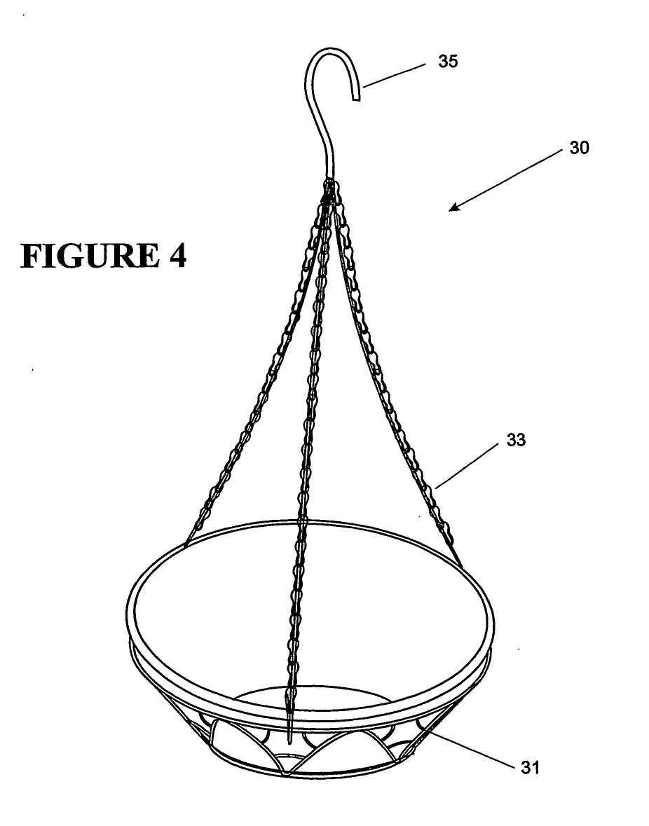

FIG. 4 shows a further embodiment of the rigid hanger member 30, which includes rigid chain members 33 and hook member 35. As with FIG. 3 the rigid hanger member 30 is shown attached to a basket 31, which is shown as an ornamental alternative to the wire basket of FIG. 3.

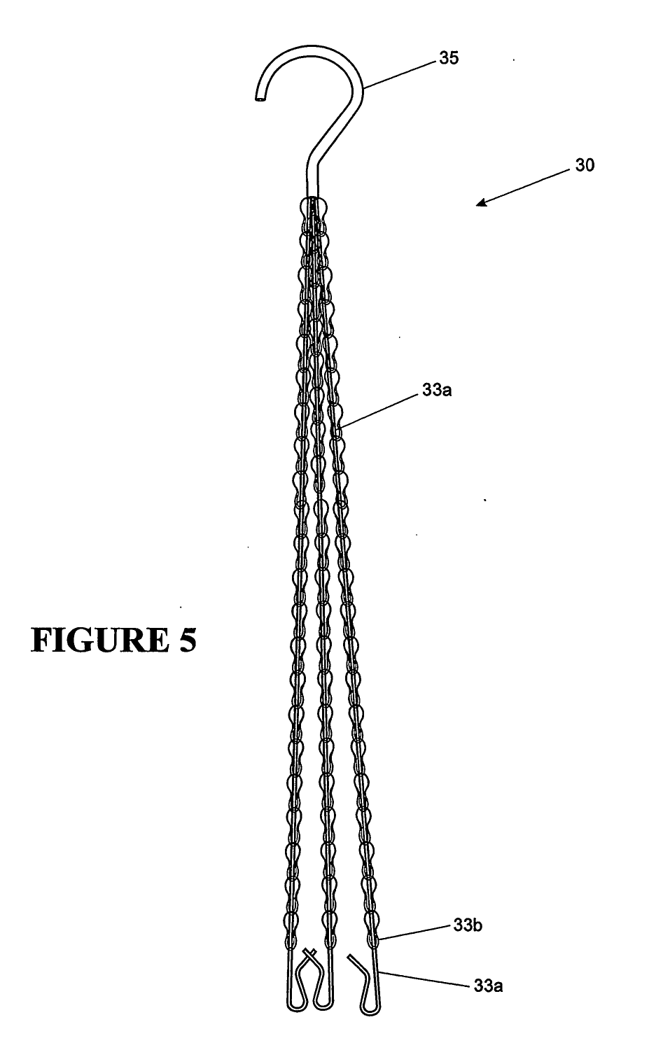

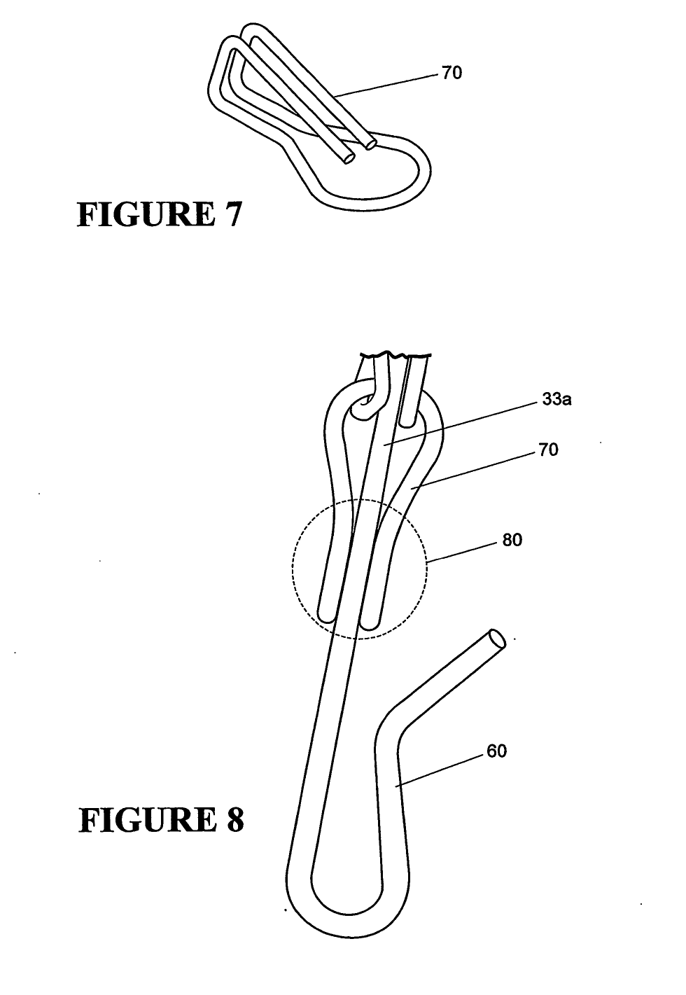

The construction of the rigid hanger member 30 is shown in FIG. 5. As before, the rigid chain member 33 includes a rigid support rod 33a and a chain 33b. Each rigid support rod 33a is attached at one end to the hook member 35 and at the other end to the basket. Thus, the weight of the basket 31 and any of its contents will be supported by the rigid support rods 33a. The chain 33b is solely cosmetic and is not load bearing. The construction of the chain will be described in greater detail below with reference to FIGS. 7 and 8.

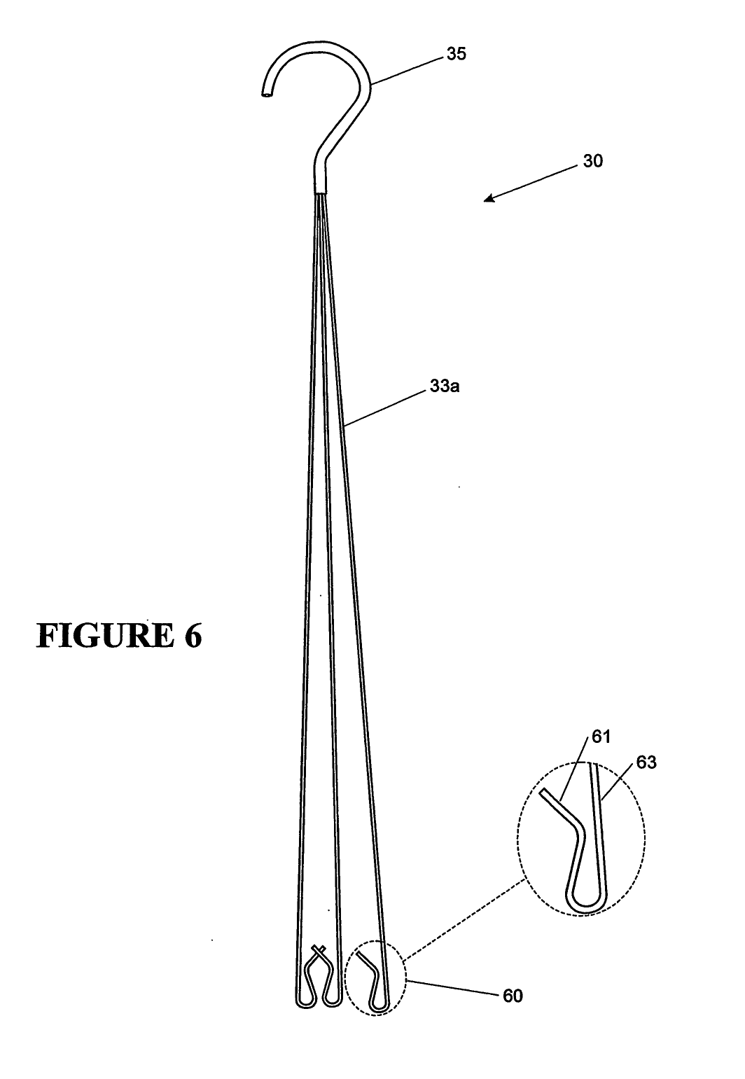

Referring to FIG. 6, the rigid support rods 33a are shown without the chain 33b attached. In the most preferred form, the rods 33a are made of high tensile wire. On one end, the rods 33a are attached to the hook member 35. In FIG. 6, this attachment is made by crimping the ends of the rods 33a inside the end of the hook member 35. For this reason, the end of the hook member 35 is substantially hollow to receive the end of the rods 33a. In the most preferred embodiment, the rods 33a extend substantially the length of the hook member 35 to ensure the rods 33a are firmly attached once crimped.

This attachment also results in the rods 33a being rigidly attached to the hook member 35. Thus, even when not in use, hook member 35 remains upright Together with the rigidity of the chain members 33, the construction of the hanger 30 as a whole is substantially rigid. Once attached to a planting basket, a user can easily attach the hanging basket assembly by supporting it from the bottom of the basket, without the disadvantage of the hook member 35 collapsing due to a lack of rigid support.

At the other end of the rod 33a, a clip or hook element 60 is provided to facilitate the attachment of the rods 33a to the upper peripheral edge of a basket. The clip or hook element is shown in the figure as a hook 60 formed by bending the end of the rod 33a back over itself. Of course other alternatives, such as moulded plastic clips that are attached to the rod 33a, can also be used.

For a firm attachment, the hook 60 is provided with an open entry 61 to easily locate the upper peripheral edge of the basket. The open entry 61 tapers to form a narrow neck 63, which prevents the basket from easily disengaging from the rod 33a once the rod 33a is attached to the basket. As previously described, attachment loops may be provided on the basket to receive the hook 60 from each of the rods 33a.

FIG. 7 shows one example chain link 70 that can be used to construct the chain 33b of the rigid chain member 33. The precise shape of the chain link is not essential and can be altered depending on the appearance of the chain 33b sought. Essentially, the chain link 70 is coupled to other chain links along the rigid support rod 33a to give the appearance of a chain 33b.

A close-up view of the attachment of the chain link 70 on the rigid support rod 33a is shown in FIG. 8. In the embodiment shown, the chain link 70 is attached to the rigid support rod 33a by virtue of spot welding, shown generally as 80. Other means, such as ties or adhesives, could be used in addition to or in replacement of the spot welding.

There is no requirement for every chain link 70 to be spot welded to the rod 33a—it is possible for only the uppermost and lowermost chain links 70 to be spot welded to the rods 33a. In this case, the chain links between the uppermost and lowermost chain links would be held firmly in place by virtue of the chain link coupling.

In an alternative embodiment, the rigid chain members may be formed from chain links which are spot welded together to provide rigidity. In yet another alternative embodiment, each rigid chain member may be formed from a single length of rod or wire which has been pre-formed and/or bent to a sinuous form over its length. This will provide the rigid chain member with a chain-like appearance. Additionally, or alternatively, the rigid chain members may be formed by plaiting together two of more lengths of rod or wire into a rigid member.

The hanging basket assembly of the present invention provides an advantage in that it includes rigid chain members which attach the basket to the hook, as opposed to non-rigid chain members. The rigidity of the chain members means that the hook is held in a preset position so that the process of hanging is easier and hence the use of two hands and/or a hanging device may not be required. Further, the rigid chain members and hook will not collapse into the basket and onto plants when the hook is not being utilised. Moreover, the present invention provides a hanging basket assembly which has the advantages of rigid supports between the hook and basket, while also maintaining the appealing aesthetics of supports with a chain-like appearance.

The foregoing description of the invention includes preferred forms thereof. Modifications may be made thereto without departing from the scope of the invention.

1. A rigid hanger member for hanging a basket for growing and/or displaying a plant or plants, comprising a hook member, and a plurality of rigid chain members, one end of which connects to the hook member and the other end of which is attached to the basket or comprises a hook or clip element for attaching to a basket.

2. A rigid hanger member according to claim 1 wherein each rigid chain member includes a rigid support rod and a chain.

3. A rigid hanger member according to claim 2 wherein each rigid chain member is configured so that its respective rigid support rod and chain are adjacent each other for their entire lengths.

4. A rigid hanger member according to claim 2 wherein one end of each rigid support rod is either attached to the basket or formed into or carries a hook or clip element for attaching to a basket, and the other end connects to the hook member.

5. A rigid hanger member according to claim 2 wherein one end of each chain is attached to the hook member.

6. A rigid hanger member according to claim 5 wherein the other end of each chain is either attached to the basket or attached to a hook or clip element for attaching to a basket.

7. A rigid hanger member according to claim 2 wherein one end of each chain is attached to the rigid support rod near the end of the rigid support rod which connects to the hook member.

8. A rigid hanger member according to claim 2 wherein the other end of each chain is attached to the rigid support rod near the end of the rigid support rod which either attaches to the basket or comprises a hook or clip element for attaching to a basket.

9. A rigid hanger member according to claim 2 wherein each rigid support rod passes through or is woven through a number of the links of its respective chain.

10. A rigid hanger member according to claim 2 wherein each chain is fixed to its respective rigid support rod at various points along its length.

11. A rigid hanger member according to claim 1 wherein each rigid chain member is composed of a series of chain links which are individually fixed together.

12. A rigid hanger member according to claim 1 wherein each rigid chain member comprises a single length of rod or wire pre-formed and/or bent to a sinuous form over its length.

13. A rigid hanger member according to claim 12 wherein the rigid chain member comprises two or more lengths of rod or wire plaited together.

14. A rigid hanger member according to claim 1 wherein the hook member is fixedly connected to the rigid chain members in a substantially upright orientation.

15. A rigid hanger member according to claim 1 wherein the hook or clip element at said other end of each rigid chain member comprises an open entry which tapers to a narrow neck.

16. A rigid hanger member for hanging a basket for growing and/or displaying a plant or plants, comprising a hook member, and a plurality of rigid chain members, each rigid chain member having a rigid support rod attached to a chain, wherein one end of each rigid support rod is either attached to the basket or formed into or carries a hook or clip element for attaching to a basket, and the other end connects to the hook member, and wherein one end of each chain is attached to the rigid support rod near the end of the rigid support rod which connects to the hook member and the other end of each chain is attached to the rigid support rod near the end of the rigid support rod which either attaches to the basket or comprises a hook or clip element for attaching to a basket.

17. A rigid hanger member for hanging a basket for growing and/or displaying a plant or plants, comprising a hook member, a plurality of rigid chain members, each rigid chain member having a rigid support rod attached to a chain, wherein one end of each chain is either attached to the basket or formed into or carries a hook or clip element for attaching to a basket and the other end of each chain fixedly connects to the hook member such that the hook member is supported in a substantially upright orientation.

18. A rigid hanger member according to claim 17 wherein each rigid support rod passes through or is woven through a number of links of its respective chain.

19. A rigid hanger member according to claim 17 wherein each rigid support rod is fixed at one end near the end of the chain which connects to the hook member while the other end of the rigid support rod is fixed near to the end of the chain which attaches to the basket or which is formed into or carries a hook or clip element for attaching to a basket.

20. A rigid hanger member according to claim 1 together with a wire basket for containing a liner, growing media and one or more plants.

21. A rigid hanger member according to claim 1 together with a basket containing a plant or plants.
